(19) United States
(12) Patent Application Publication
(10) Pub. No.: US 2021/0012365 A1
(43) Pub. Date: Jan. 14, 2021

(54) System and Method for Content Assessment

(71) Applicant: Stephen Andrew Klava, Evanston, IL (US)

(72) Inventor: Stephen Andrew Klava, Evanston, IL (US)

(21) Appl. No.: 16/508,248

(22) Filed: Jul. 10, 2019

(51) Int. Cl. G06Q 30/02; G06Q 20/06

(52) U.S. Cl. CPC G06Q 30/0217; G06Q 50/01; G06Q 30/0208; G06Q 20/0655

(57) ABSTRACT

System and method for content assessment is disclosed. The system has a memory, a processor connected to the memory, a receiving function, a decrease balance function, an increase subject value function, and a making subject value available function. The receiving function is configured to receive, from a first user via a first client device, a request to indicate approval of a subject. The decrease balance function is configured to decrease a user balance associated with a first user account of the first user. The increase subject value function is configured to increase a subject value associated with the subject record associated with the subject. The making subject value available function is configured to making at least a portion of the subject value available for a second user, other than the first user, to redeem for use in experiencing the subject.

### FIELD OF THE INVENTION

This invention relates in general to a system and method for content assessment.

### BACKGROUND OF THE INVENTION

Certain online social media websites provide an ability for a user to provide feedback about a given piece of content. For example, the Facebook social media website allows a user to “like” a given piece of content. A user can “like” a given piece of content by selecting the appropriate “like” icon or the word “like.” However, given the ease of “liking” a piece of content a user may feel obligated to like content that he or she does not like, such as due to social pressure. This possibility of false liking makes the measure of “likes” less valuable as a reliable indicator of the popularity of the corresponding content.

The present inventor recognized the need for a system that reduces the chances of false positive ratings of a subject. The present inventor recognized the need for a system where the user must be more invested in providing authentic indications of approval of a given subject. The present inventor recognized the need for a system that facilitates more authentic reviews from users. The present inventor recognized the need for a system where a user must provide something of value to indicate approval of a subject. The present inventor recognized the need for a system that provides search features and sorted results of content based on higher fidelity user feedback.

### SUMMARY OF THE INVENTION

A computer implemented method of content assessment is disclosed. A request to indicate approval of a subject is received from a first user. A user balance associated with a first user account of the first user is decreased. A subject value associated with the subject record associated with the subject is increased. At least a portion of the subject value is made available for another user to redeem for use in experiencing the subject.

An approval indicating system is disclosed. The system has a memory, a processor connected to the memory, a receiving function, a decrease balance function, an increase subject value function, and a making subject value available function. The receiving function is configured to receive, from a first user via a first client device, a request to indicate approval of a subject. The decrease balance function is configured to decrease a user balance associated with a first user account of the first user. The increase subject value function is configured to increase a subject value associated with the subject record associated with the subject. The making subject value available function is configured to making at least a portion of the subject value available for a second user, other than the first user, to redeem for use in experiencing the subject.

Numerous other advantages and features of the present invention will become readily apparent from the following detailed description of the invention and the embodiments thereof, from the claims, and from the accompanying drawings.

### BRIEF DESCRIPTION OF THE DRAWINGS

FIG. 1 is a block diagram of an example operating environment for a content assessment system of the invention.

FIG. 2 is a block diagram of one embodiment of the assessment system of FIG. 1.

FIG. 3 is a flow diagram of an approval indicating function of the assessment system.

FIG. 4 is a flow diagram of a value redemption or use function of the assessment system.

FIG. 5 is a user interface of the assessment system.

FIG. 6 is a diagram of actions to add value of the assessment system.

FIG. 7 is a diagram of a subject record of the assessment system.

FIG. 8 is a diagram of a user record of the assessment system.

FIG. 9 is a block diagram of an example client device architecture.

FIG. 10 is a block diagram of an example server architecture.

### DETAILED DESCRIPTION

The following description is presented to enable any person skilled in the art to make and use the invention. For the purposes of explanation, specific nomenclature is set forth to provide a plural understanding of the present invention. While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

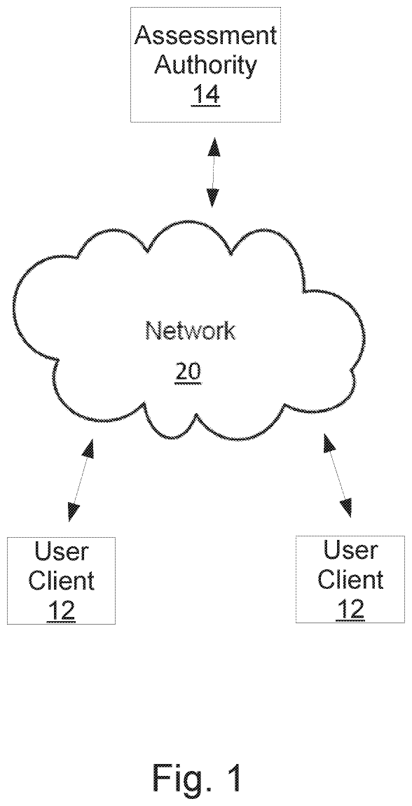

FIG. 1 shows an example operating environment for an assessment authority 14. In one embodiment, a content assessment system 10 may comprise the assessment authority 14 and a user client device 12. FIG. 1 shows that multiple user client devices 12 can communicate with the assessment authority 14 across the network 20.

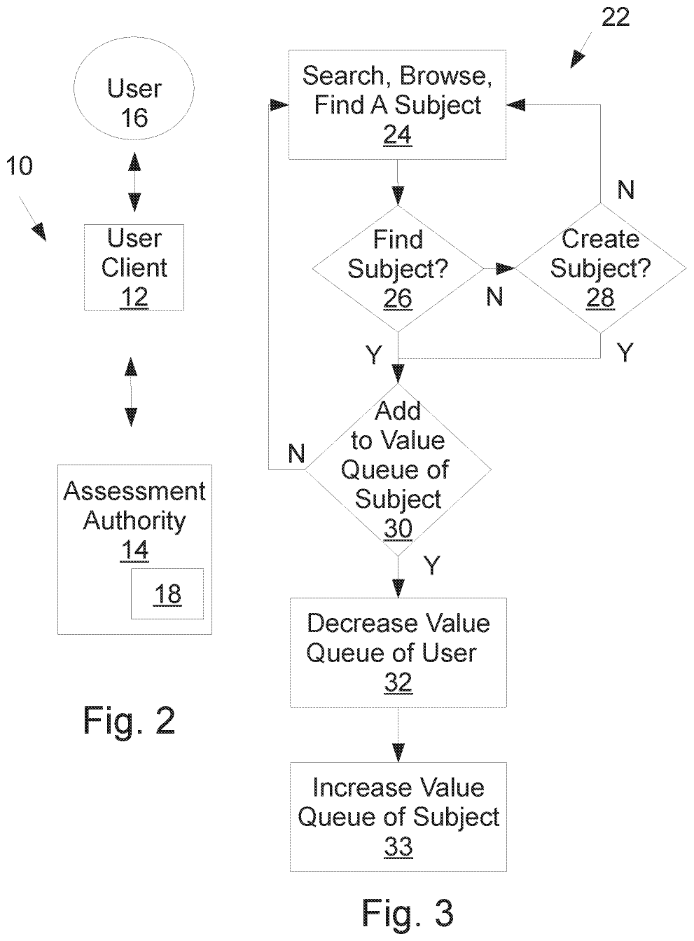

FIG. 2 shows communications and instruction routes between the various components of a first embodiment of the system 10 across the network 20. Such communications and/or instruction routes may be wired and/or wireless communications and/or instruction routes. The assessment authority 14 is in electronic or signal communication to the user client device 12. The user 16 uses the user client device 12.

The assessment authority 14 may comprise or be in communication with a data store 18, which may be one or more databases. The data store can be configured to contain one or more subject records 76 and one or more user records 90. In some embodiments, the subject records 76 may be in a different data store from the user records 90.

FIG. 3 shows an exemplary approval indication function 22. When a user desires to indicate approval of a subject, the user will reach a digital representation of the subject. The user can reach the digital representation of a subject in a number of ways, including searching, browsing, or following a direct link to the digital representation of a subject at step 24. The assessment authority 14 provides a search function for searching the datastore for subject records having data for the digital representation of a subject. The search function has a transmit function for transmitting for display, on the client device, the search results of a search by the search function. The search function also permits a user to enter search terms for searching against the datastore for records matching the search terms, or in some cases records near matching the search terms. Other search techniques of the data store of subject records can be used.

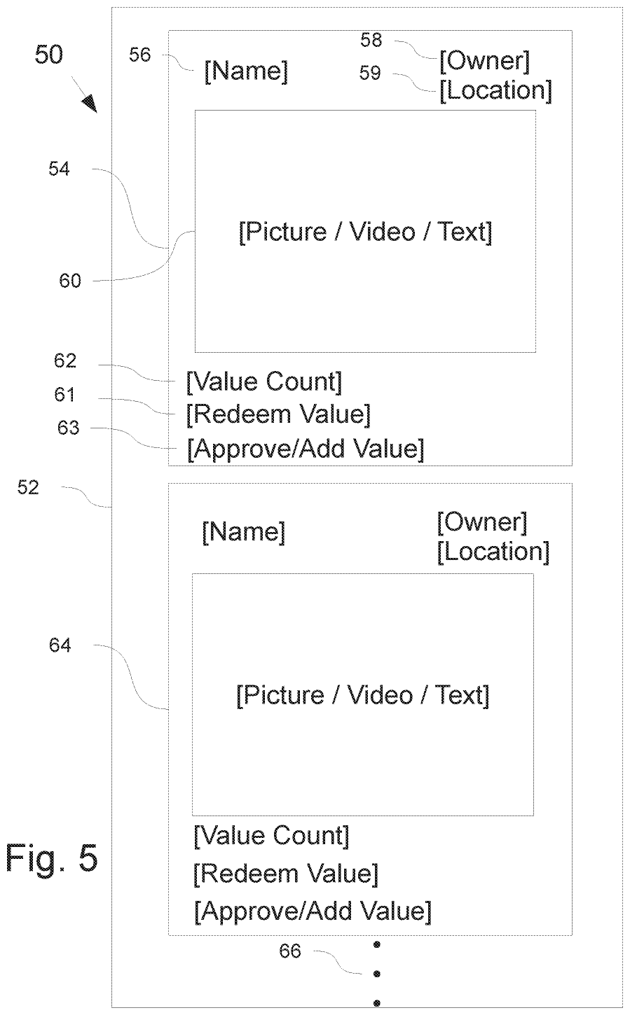

In some embodiments, the search results are presented in decreasing order based on value balance 87, with the subject/content having the highest value in the value balance section 87 at the top of the result list. In this manner the most approved-of content(s) will be shown first to the searching user. Similarly, any result list, whether by searching, browsing or otherwise, may be ordered based on value balance 87, with the subject/content having the highest value in the value balance section 87 at the top of the result list. In some embodiments, the search results are displayed in the manner shown in FIG. 5.

The assessment authority 14 provides a browse function for browsing digital representation of subjects with data provided in records in the datastore. The browse function may provide a hierarchy of selectable subjects arranged by topic, geographic area, activity, price, value balance count, or other measures. In some embodiments, the browse results are displayed in the manner of FIG. 5. The assessment authority 14 provides a direct link access function for directly accessing the digital representation of a subject through a unique address. In some embodiments, the unique address is saved in the address section 88 of the subject record 76. In some embodiments, the unique address is a unique uniform resource locator (URL). The assessment authority 14 receives a request for the unique address, it will serve to the user client device data for display containing or representing some or all of the data in the corresponding subject record. In some embodiments, the display will be in the format of tile/area 54 of FIG. 5.

If the authority 14 cannot find a digital representation of the subject at step 24 and 26, then the authority can prompt the user to create a new subject record at step 28. If the user agrees to create a new subject record, the authority will prompt the user to enter certain information about the subject. The authority may also request the user client device provide information, such as location information of the user client device, such as when the user is at the location of the subject.

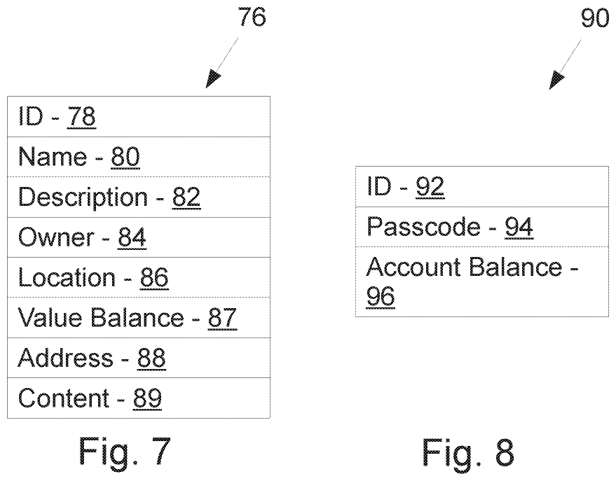

FIG. 7 shows an exemplary subject record 76. The record comprises an ID section 78, a name section 80, a description section 82, a owner section 84, a location section 86, a value balance section 87, an address section 88, and a content section 89. The ID section 78 may comprise a unique identification representation such as a number, a string of characters, or an alphanumeric combination. The unique identification may be used in combination with a URL to designate a unique address where the content of the record can be accessed, and in which case address section 88 may not be used. The name section 80 will include the name of the subject. In the case where the subject is a menu item, the name of the menu item, such as, Stir Fry Chicken, will be listed in name section 80. The description section 82 will include a description of the subject. Where the subject is a menu item, the description will further describe the menu item. The owner of the subject will be listed in the owner section 84. When the subject is a menu item, the owner could be the restaurant where the menu item is available, for example, John's Stir Fry Restaurant. The location section 86 will comprise the geographic location where the subject is located or is available. Where the subject is a menu item the geographic location can be the geographic location where the restaurant is located and the menu item is available. The location section can comprise a street address, and or geolocation data, and or a latitude and longitude data. Where the subject doesn't have a physical location, the location section 86 can comprise a digital location such as a URL where the subject is located. In some applications even where there is a physical location section 86 also includes digital location information where the subject can be located online.

Record 76 further comprises a value balance in the value balance section 87. The value balance 87 holds a representation of value associated with the subject. In some embodiments, the value is represented as points. The value may be represented as a number representing the quantity of value associated with the subject. The address section 88 comprises a digital address where the digital representation corresponding to the subject can be accessed.

At step 28, the assessment authority will prompt the user to enter a name to be saved in the name section 80, a description for the subject to be saved in the description section 82, and the owner's name of the subject to be saved in the owner section 84. In some embodiments the authority 14 will request the user enter location information corresponding to the geographic location of the subject. In some embodiments, the authority 14 will request the user client device 12 to provide its location. This may be useful when the user is at the location where the subject is located, so that the user does not have to manually enter geographic location information and further so that such geographic location information can be accurate as determined by geolocation functionality of the user's client device. The geolocation functionality of the user's client device may be GPS functionality, Wi-Fi or Bluetooth based geolocation functionality, other geolocation functionality, or a combination thereof.

With the information provided by the user or by the user's client device, the authority will create a new subject record 76, storing information in the corresponding section of the subject record. The authority 14 may generate a unique ID for storing in the ID section 78. Further the authority may set the value in the value balance section 87 to an initial value. In some embodiments the initial value is zero. In some embodiments the initial value is a value that is greater than zero.

At step 30, the authority provides the user with the option to add value to the value balance of the subject. That option may be provided in the form of a button or icon such as the approve or add value selector 63 of FIG. 5. If the user selects to add value to the value balance of the subject then at step 32, the authority will check to see that the account balance in the account balance section 96 of the user record 90 associated with the user has a sufficient value corresponding to the value that the user desires to transfer to the value balance of the subject. In one embodiment, the system allows only a value increment of one to be added to the value balance of the subject by a user.

In other embodiments, the authority allows a value increment of one or more than one to be added to the value balance of the subject by a user. In the embodiment where the value increment is one, the authority 14 will check that the balance section 96 of the user record 90 comprises a value of at least one. In the embodiment where the value increment is greater than one, the authority will check that the balance section 96 of the user record 90 comprises a value of greater or equal to the value sought to be transferred to the value balance of the subject. If the balance section 96 of the user record corresponding to the user is greater or equal to the value sought to be transferred to the value balance of the subject, then at step 32, the system will decrease the value in the balance section 96 of the user record 90 corresponding to the user by the value transferred to the subject record. At step 33, the authority will increase the value balance of the value balance section 87 of the subject record 76 corresponding to the subject by the value sought to be transferred by the user. Therefore, the value in the balance section 96 will be decreased by the amount that the value balance of the subject has been increased, thereby effectuating a transfer of the value from the user's account to the subject record. In some embodiments, the value in the balance section 96 of the user record will be decreased after or at the same time as the value balance 87 of the subject is increased.

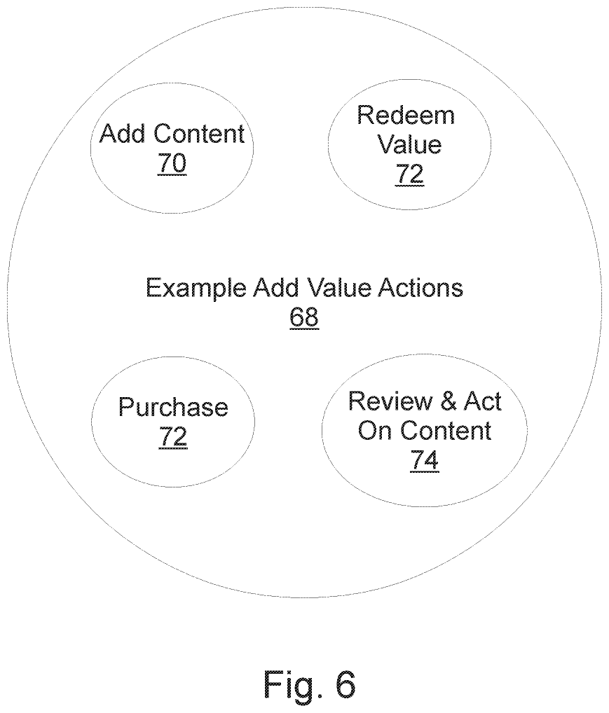

In some embodiments, the value in the value balance section 87 of a subject can be redeemed or used by other users. The value can take the form of a discount usable in the purchase of the subject. For example, the value can represent a $5 discount on a menu item. When another user redeems or uses the value in the value balance, that other user receives the value, e.g. a discount on the menu item. Users can increase the value in the user's balance section 96 of the user's record by a number of value increasing activities that the authority 14 is configured to recognize, as further explained below in connection with FIG. 6.

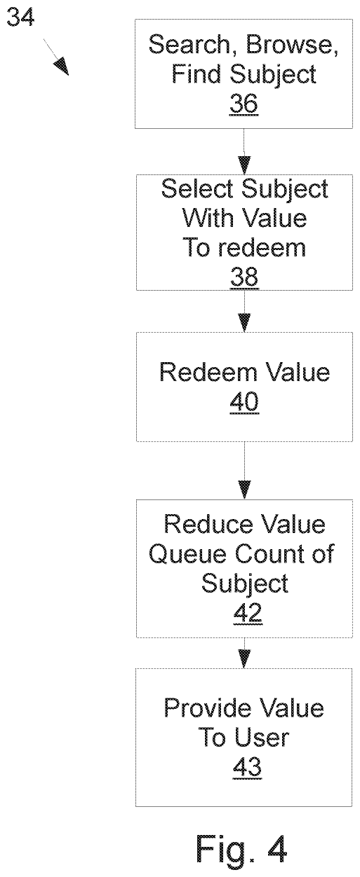

FIG. 4 show an exemplary value redemption or use function 34 of the authority 14. At step 36 the user finds a subject, for which he/she would like to redeem value. This may be done using the authority's 14 search function, browse function, or direct access function, discussed above. When the user finds a subject that he/she seeks to redeem value for, the user may select to redeem the value corresponding to that subject. In some embodiments, the user may do this by selecting the redeem selector 61 shown in FIG. 5. When the authority receives a request to redeem value associated with a subject of a subject record, at step 42 the system will reduce the value in the value balance section 87 of the subject record by a redemption amount. In some embodiments, the redemption amount is 1 unit. In some embodiments, the redemption amount is more than 1 or more than 1 unit.

Then at step 43, a value provide function of the authority 14 will provide the value associated with the redemption amount to the user. In some embodiments, the 1 unit of redeemed value has an equivalent value in fiat currency, such as 0.00001 dollar, 0.01 dollar, 1 US dollar, or 5 US dollars, or 20 US dollars, etc. In some embodiments, the 1 unit of redeemed value can correspond to any value in fiat currency.

In some embodiments, the value provide function transmits for display on the user client device a representation of the redeemed value. In some embodiments, the representation of the redeem value is a coupon or voucher. In one example, the coupon or voucher displays a bar code or QR code or other code that can be read at the location of the subject at or about the time of redemption to ensure the coupon is valid. In some applications, the value of the redemption amount is equal to the cost of the subject, so that when the user uses the value the subject is received without additional payment. In some applications, the value of the redemption amount is less than the cost of the subject, so that the user receives a discount when purchasing the subject. In some embodiments, the value provide function transmits to the user client device a representation of the redeemed value and such representation can be displayed and/or printed and presented to the owner or representative of the subject at the point of purchase, rent, redemption, or experience.

In some embodiments, the representation of the redeemed value represents a digital currency, a currency within the system, a representation of reputation of the user within the system, or reward points.

The subject matter that can be a subject associated with a subject record is broad. In some embodiments, the subject is a thing, a person, a place, an activity, a service, or a product. In some embodiments, the subject is an intangible, such as an idea, a noun, or a cause.

In some embodiments, when the authority 14 receives a request to redeem value associated with a subject of a subject record, at step 42 the system does not reduce the value in the value balance section 87 of the subject record by a redemption amount or any other amount. In some embodiments, the authority provides a quantity of value to a user in response to a request to redeem value based on the value balance section of the subject record. In some embodiments, the authority provides a quantity of value to a user in response to a request to redeem value based on a ranking of the corresponding subject. The ranking is based on the value in the value balance section of the subject record. In some embodiments, the ranking includes tiers, such as tier 1, tier 2, tier 3, tier 4, etc. When the value in the value balance section of the subject record reaches a predefined tier threshold value, the authority will increase the tier rank associated with the subject. The authority will provide a higher redemption value in response to a request to redeem value associated with a subject of a subject record for subjects with a value balance corresponding to a higher tier ranking. For example, the authority might provide 100 units of value for a subject with a 4^{th} tier value balance, 500 units of value for a subject with a 3^{rd} tier value balance, 1000 units of value for a subject with a 2^{nd} tier value balance, and 2000 units of value for a subject with a 1^{st} tier value balance. Other predefined threshold values can be provided for each tier. Therefore, in some embodiments, the authority will provide users requesting redemption of subjects with higher value balances with higher amounts of redeemed value, (e.g. units, points, currently, discounts) than subjects with lower value balances corresponding to lower tiers.

FIG. 5 shows a user interface 50 comprising subject information tiles or areas 54, 64. The tiles have information about a subject from subject records 76 in the datastore 18. In FIG. 5, tile 54, 65 are identical in format so only tile 54 will be described. However, in some embodiments, each tile does not have the same format. The continuation dots 66 indicate that more than two tiles can be presented to the user. Further, the interface served from the authority 14 may allow the user to scroll the list of tiles so that new tiles below may become visible on the user's screen on the client user device. Therefore, the authority may serve to the user device and user may scroll through any number of tiles in the tile stream.

In some embodiments, the tile 54 comprises a name section 56, an owner section 58, a location section 59, a content section 60, a value balance count indicator 62, a redeem value selector 61, and an add value selector 63.

The name section 56 will have the name of the subject from the name section 80 of the subject record. The owner section 58 will have the owner from the owner section 84 of the subject record. The location section 59 will have the location information associated with the subject form the location section 86 of the subject record. The content section will have the content from or linked to in the content section 89 of the subject record. The content can be any information, such as text, a photo, a video, or a combination of some or all of the forgoing. The content will be of or related to the subject. The value balance count indicator 62 will have a count of or a representation of the value amount in the value balance section 87 of the subject record. The redeem value selector 61 is an item that the user can select to redeem value in the value balance of the associated subject according to the value redemption or use function 34 explained above. The add value selector 63 is an item that a user can select to add value to the value balance of the associated subject according to the function for indicating approval 22 of a subject, explained above.

The authority 14 provides an add value to user account function. FIG. 6 shows exemplary actions to add value 68. In some embodiments, the authority will be configured to increase the balance in the balance section 96 of the user record associated when the user adds content 70 to the authority 14. The added content can be the addition of a subject, such as according to steps 26 and 28 above.

In some embodiments, the authority will be configured to increase the balance in the balance section 96 of the user record associated when the user reviews and acts on content 74. In some application, acceptable action that results in an increase in the balance of the user record are when a user flags content as inappropriate, such as being off topic or offensive. In some embodiments, the authority is configured to provide an increase in the balance in the balance section 96 of the user record associated with a user that provides a fait money payment to the authority or a system or bank account associated with the authority.

In some embodiments, the authority is configured to provide an increase in the balance in the balance section 96 of the user record associated with a user that redeems value from a subject 72, such as shown in function 34. In some embodiments, the assessment authority is configured to designate the redeemed value as useable only in connection with experiencing the subject from which the redeemed value was received.

Each user of the assessment authority will have a user account corresponding to a user record 90. An exemplary user record 90 in shown in FIG. 8. An ID section 92 contains a unique identifier of the user. The passcode section 94 comprises a password or code used to authenticate a user's access to the assessment authority. The balance section 96 contains a representation, such as a numeric representation, of the balance of useable value in the user's account. In some embodiments, the user account may have more or less sections.

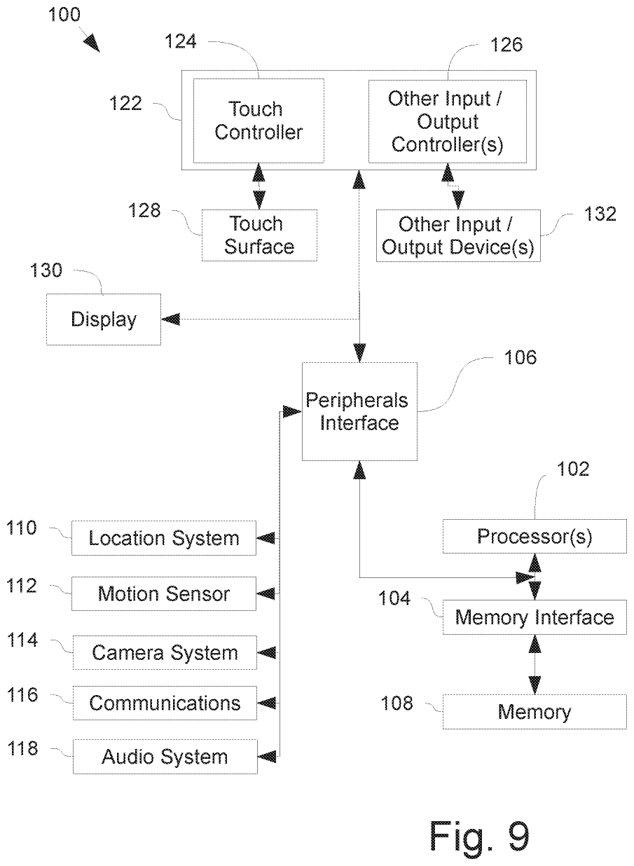

FIG. 9 is a block diagram of an example client device architecture 100 for implementing the features and processes described herein, such as described in reference to user client device 12. The architecture may be implemented in a mobile or stationary electronic device for implementing the features described herein, including but not limited to, desktop computers, portable computers, smart phones, tablet computers, portable electronics, and the like.

The architecture 100 provides a processor 102 connected to a memory interface 104 and a peripheral interface 106 across one or more internal communication channels, such as a bus(es). The memory interface 104 is connected to the memory 108. In some embodiments, the memory is connected directly to the processor or through one or more intermediate elements. In some embodiments, a peripheral interface is connected to one or more of: a location sensor 110, a motion sensor 112, a camera system 114, a communication system 116, an audio system 118, and an input output system 122. In some embodiments, one or more components or systems connected to the peripheral interface is instead connected directly, or through one or more intermediate components, to the processor and or memory.

The camera system 114 comprises or is connected to one or more cameras or optical sensors capable of capturing still image(s) and or video. The camera system can carry out camera functionality in whole, or in part, such as in connection with the processor and or other components. In some embodiments, the camera or optical sensor can comprise or be a charged coupled device or a complementary metal-oxide semiconductor. In some embodiments, the camera system comprises multiple cameras, such as a front facing camera and an opposite user facing camera.

The location system 110 may comprise a location processor. The location system comprises functions for determining the location of the architecture. In some embodiments, the location system 110 comprises GPS functionality, which uses data/signals transmitted from satellites to determine location. In some embodiments, the location system may use other inputs, such as other signals, including Wifi signals, to determine a location or an estimated location of the architecture or to enhance the accuracy of the location determination.

The one or more communication systems 116 provide communication functions. The communication systems may comprise a wireless communication system and/or wired communications system. Wireless communications systems may include radio frequency receivers and transmitters. The wired communication system may comprise a one or more ports, such as a universal serial bus port, or other wired port for connecting to other computing devices.

The communications system 116 may be designed to function on or in connection with one or more communication networks. For example, a wireless communication system may be design to operate using protocols, such as, GPRS, enhanced data GSM environment (EDGE), IEEE 802.x (including WiFi), global system for mobile communications (GSM), code division multiple access (CDMA), Near Field Communications (NFC), and or Bluetooth®. The communication system can be configured to connect with a host device.

In some embodiments, the input output (I/O) system 122 comprises a touch controller 124 and one or more other input/output controllers 126. The touch controller 124 is connected to a touch surface 128. In some embodiments, the touch surface 128 and touch controller 124 are configured to detect contact and movement or break of contact and movement using one or more touch sensitive technologies. Such touch sensitive technologies may include capacitive, infrared, resistive, and surface acoustic wave technologies, and or other components for determining one or more points of contact or break of contact with the touch surface 252. In some embodiments, the touch surface comprises or is used with a display 130. In some embodiments, the display is connected to the input output (I/O) system 122. In some embodiments, the touch surface is configured to display a virtual keyboard for use as an input device by the user.

The other input and/or output controllers 126 are connectable with other input and/or output devices 132, such as a USB port, a keyboard, a mouse, and/or one or more other buttons. In some embodiments, the motion sensor 112 is configured to detect movement and orientation of the device. In some embodiments, the motion sensor 112 comprises an accelerometer and/or a gyroscope.

In some embodiments, the audio system comprises a speaker and or a microphone. The microphone is configured to detect and receive audio. The audio system may be configured to record or transfer to the memory for recording audio detected by the microphone. The audio system can be configured to play audio content and signals via the speaker or through external speakers. In some embodiments, the microphone, speaker, and external speaker may be another input/output device 132 connected to the input output system.

In some embodiments, the memory 108 comprises one or more of: random access memory, one or more magnetic disk storage devices, one or more optical storage devices, one or more solid state drives, and/or flash memory. The memory may comprise volatile and or nonvolatile memory. The memory 108 stores an operating system, such as OS X, ANDROID, LINUX, UNIX, or WINDOWS. The operating system instructions may handle certain system services and perform tasks involving hardware components, among other things.

The memory 108 comprises instructions for enabling and providing functionality of the device. The memory 108 comprises instructions to enable communication with one or more additional devices, and or one or more computers or servers, such as described herein.

Further, in some embodiments, the memory comprises instructions for one or more of: graphic user interface processing, sensor functions, phone functions, electronic messaging functions, web browsing functions, media processing functions, audio functions, and camera functions. The memory can comprise other instructions, such as for performing some or all of the processes described herein, such as regarding device 12. The memory 108 may include additional instructions or fewer instructions. Further, functions of the device architecture and of the device 12 may be implemented in hardware and/or in software.

The client device 12 may comprise other architectures, comprising more or fewer components. For example, in some embodiments, the client device comprises a processor, a memory, a wireless transceiver, a display, an input device, and one or more communication channels. The one or more communication channels connecting the memory to the processor. The one or more communication channels may also connect the wireless transceiver, the display, and the input device to the processor and/or the memory.

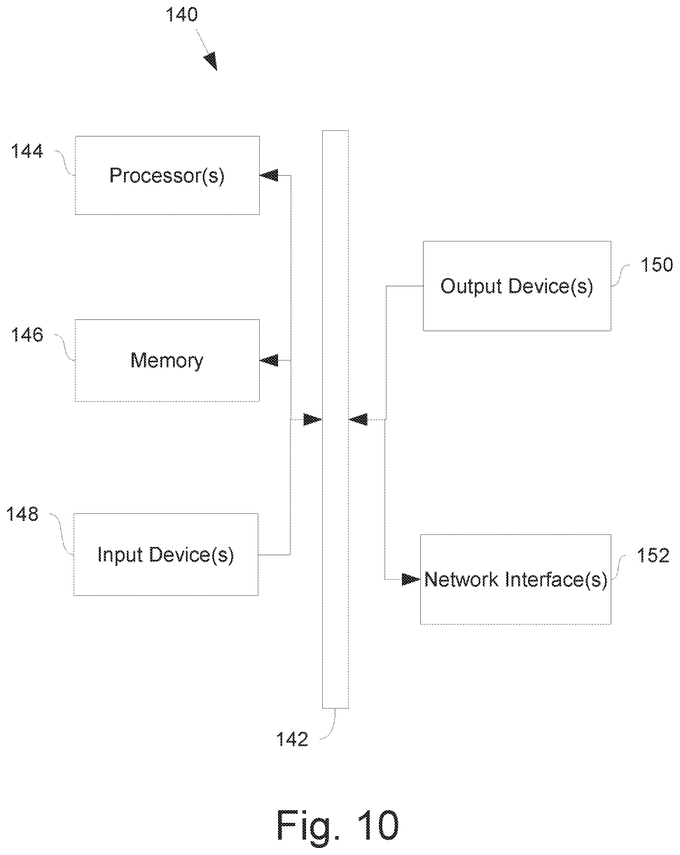

FIG. 10 provides a block diagram of an example server computer architecture 140 for implementing the features and processes described herein, such as in reference to the assessment authority 14 or to other server side functionality. In some implementations, the architecture 140 comprises one or more communication channels 142, such as a bus that connects one or more processors 144, a memory 146, one or more input devices 148, one or more output devices 150, and one or more network interfaces 152. The one or more communication channels 142 allow the transfer of data and communications between the components connected to the channels 142.

The network interface(s) 152 may comprise wired and/or wireless network interfaces, such as an Ethernet wired network interface. The input device(s) 148 may comprise a keyboard, a mouse. The output device(s) 150 may comprise a display, such as an LCD display or a touch sensitive display. In some embodiments, the input device is also an output device, such as a touch sensitive display. The memory may comprise computer readable medium(s) such as random access memory, one or more magnetic disk storage devices, one or more optical storage devices, one or more solid state drives, and/or flash memory. The memory may comprise volatile and or nonvolatile memory.

The memory 146 may comprise an operating system, network communication instructions, and the instructions for operating the assessment authority 14. The operating system can perform tasks such as managing files on the memory, managing communications on the one or more communication channels 142, receiving and reading input from input devices 148, and providing output to output devices 150, among other tasks. The network communications instructions can enable the connection and maintenance of network communications. The assessment authority 14 may comprise other architectures, including those with more or few components.

The steps, functions, processes, and capabilities described herein can be provided in the form of instructions stored in a computer readable medium and executable by a processor of a computing device to achieve the corresponding functions, processes, capabilities, or results.

From the foregoing, it will be observed that numerous variations and modifications may be affected without departing from the spirit and scope of the invention. It is to be understood that no limitation with respect to the specific apparatus illustrated herein is intended or should be inferred. For example, one or more component embodiments may be combined, modified, removed, or supplemented to form further embodiments within the scope of the invention. As a further example, steps provided in the flow diagrams of the figures, could be carried out in a different order to achieve desired results. Further, steps could be added or removed from the processes described. Therefore, other embodiments and implementations are within the scope of the invention.

1. A computer implemented method for content assessment:
receiving, from a first user via a first client device, a request to indicate approval of a subject;
decreasing a user balance associated with a first user account of the first user;
increasing a subject value associated subject record associated with the subject; and,
making a least a portion of the subject value available for a second user, other than the first user, to redeem for use in experiencing the subject.

2. The method of claim 1, the step of making the increased subject value available comprises the step of making a coupon available for a second user to redeem for use in receiving a discount in connection with the subject.

3. The method of claim 1 wherein,
the step of decreasing a user balance is further defined in that the user balance is decreased by a first value; and
the step of increasing the subject value is further defined in that the subject value is increased by the first value.

4. The method of claim 3, wherein the first value is represented as one or more points.

5. The method of claim 1, wherein
the step of decreasing the user balance comprises the steps of:
determining that the user balance is greater than zero;
decreasing a user balance associated with a first user account of the first user in response to the user balance being greater than zero; and,
the step of increasing a subject value is further defined in that the subject value associated subject record associated with the subject is increased in response to the user balance being greater than zero.

6. The method of claim 1, comprising the step of:
receiving, from the second user, a request to redeem value associated with the subject;
decreasing a value balance associated with subject record; and,
sending to the second user a voucher for use in experiencing the subject.

7. The method of claim 6, comprising the step of:
determining that the value balance is greater than zero;
wherein the step of decreasing a value balance is further defined in that the decreasing is in response to the value balance being greater than zero;
wherein the step of sending to the second user is further defined in that the sending is in response to the value balance being greater than zero before the step of decreasing the value balance.

8. The method of claim 1, wherein the step of making the subject value available for a second user comprises the step of sending to a second client deice for display to the second user a representation of a quantity of the subject value available for redemption.

9. The method of claim 1, comprising the step of increasing the user balance in response to receiving from the first user content, a review of content, or a payment.

10. A subject assessment system, comprising:
a memory;
a processor connected the memory;
a receiving function configured to receive, from a first user via a first client device, a request to indicate approval of a subject;
a decrease balance function configured to decrease a user balance associated with a first user account of the first user;
a increase subject value function configured to increase a subject value associated subject record associated with the subject; and,
a making subject value available function configured to making at least a portion of the subject value available for a second user, other than the first user, to redeem for use in experiencing the subject.

11. The system of claim 1, wherein the making subject value available function is configured to make a coupon available for a second user to redeem for use in receiving a discount in connection with the subject.

12. The system of claim 10, wherein the decrease balance function is configured to decrease the user balance by a first value; and the increase subject value function is configured to increase the subject value by the first value.

13. The system of claim 10, wherein the method of claim 1, wherein decrease balance function is configured to determine that the user balance is greater than zero and decrease a user balance associated with a first user account of the first user in response to the user balance being greater than zero, the a increase subject value function is configured to increase the subject value in response to the user balance being greater than zero.

14. The system of claim 10, comprising a redemption request receiving function configured to receive, from the second user, a request to redeem value associated with the subject; a value balance adjustment function configured to decrease a value balance associated with subject record in response to receiving the request to redeemvalue associated with the subject; and, a sending function configured to send to the second user a voucher for use in experiencing the subject.

15. The system of claim 14, wherein the a value balance adjustment function is configured to determine that the value balance is greater than zero and decrease the value balance in response to the value balance being greater than zero; the sending function is configured to sending to the second user the voucher in response to the value balance being greater than zero.

16. The system of claim 10, wherein the making subject value available function is configured to send to a second client deice for display to the second user a representation of a quantity of the subject value available for redemption.

17. The system of claim 10, comprising an increase user balance function configured to increase the user balance in response to receiving from the first user content, a review of content, or a payment.

18. The approval indicating apparatus, comprising:
a memory;
a processor connected the memory;
a means for receiving, from a first user via a first client device, a request to indicate approval of a subject;
a means for decreasing a user balance associated with a first user account of the first user;
a means for increasing a subject value associated subject record associated with the subject; and,
a means for making at least a portion of the subject value available for a second user, other than the first user, to redeem for use in experiencing the subject.

19. (canceled)
